(19) United States
(12) Patent Application Publication
(10) Pub. No.: US 2010/0240308 A1
(43) Pub. Date: Sep. 23, 2010

(54) DIGITAL VOICE MESSAGE SYSTEM

(75) Inventor: Thomas Downes, London (GB)

Correspondence Address: STITES & HARBISON, PLLC, 400 W MARKET ST, SUITE 1800, LOUISVILLE, KY, 40202-3352, US

(73) Assignee: QUAIL LIMITED, London (GB)

(21) Appl. No.: 12/526,147

(22) PCT Filed: Feb. 6, 2008
(86) PCT No.: PCT/GB08/00410

§ 371 Date: May 18, 2010

(30) Foreign Application Priority Data
Feb. 6, 2007 (GB) 0702285.8

(51) Int. Cl. H04B 7/00

(52) U.S. Cl. 455/41.3; 704/270

(57) ABSTRACT

A digital voice message system for large retail stores and supermarkets including a terminal at the point of sale comprising a touch screen (104) adapted to receive a plurality of inputs from an operator wherein said terminal sends a message to a base station (201), said message comprises a signal indicating the” identity of the terminal where the signal is initiated and a message relating to or consisting of the input entered into the terminal. The system further comprises a radio packet transmitter (105) for transmitting the message from the point of sale terminal to the base station (201). In addition, the base station (201) is adapted to send a signal to an apparatus (202) capable of reproducing the message, wherein said apparatus or primary station transmits audio signals to a plurality of headsets (204) or other audio reproducing systems. The system further comprises secondary slave base stations (203) linked to the master base station (201) via cable link, said secondary slave base stations (203) are used to cover a wider transmission area.

The present invention relates to a voice message system in particular, but not exclusively, for large retail stores and supermarkets.

Large retail stores such as supermarkets are increasingly busy, consequently, communication systems have become invaluable for efficient service at the checkout or point of sale. In smaller stores systems can work effectively throughout the retail store. Communication systems are typically used to make requests between staff members in offices or warehouses and the shop floor as well as between different members of staff within departments, particularly between supervisors and checkout operators. Traditional communication systems have included telephones, light signals, intercoms and bells.

However, traditional systems have problems in accurate, precise and quick communication; in addition, the signals used may be ignored or overlooked, as a result, check out operators are often compelled to repeat the signal. Telephones and intercoms experience a high level of background noise from within the store, making it difficult to hear the requests accurately. Further, telephone based systems require a physical presence at the receiver when a request is being made.

Other traditional communication methods such as bells and lights involve a supervisor communicating with the checkout operator to establish the problem first and then taking appropriate action. This process often involves going to the checkout, subsequently going somewhere else for additional information or items and finally returning to the checkout to resolve the issue. Accordingly, considerable delay may be caused in practice.

In particular, in retail outlets such as supermarkets checkouts are known to be a bottle neck for customer throughput. Stoppages at the checkouts increase the time spent there and, consequently, reduce efficiency, lead to annoyance of customers and delays. While customer throughput may be increased by adding extra checkouts, increasing the number of checkouts causes the floor space to be used less effectively, for example to display goods. In addition, due to the additional capital and running costs associated with additional checkouts, retail stores have been aiming to increase efficiency at individual checkouts by reducing the delay caused by queries and other operations which necessitate communication with supervisor or other members of staff.

The present invention therefore seeks to provide a system to improve communication at checkouts, thereby increasing customer throughput. The method used to implement the invention will depend on the existing point of sale terminal system and the required flexibility of system in accordance with the business.

According to the invention there is provided a point of sale terminal system having a touch screen adapted to receive inputs from an operator, the inputs including a plurality of inputs relating to preset messages, wherein when an operator selects one of the preset messages, the point of sale terminal sends a message to a base station, the message comprising an identifier for the point of sale terminal and an identifier relating to or comprising the preset message, the base station being adapted to send a message to apparatus adapted to reproduce the preset message and the point of sale identifier.

Preferably, the system comprises a radio packet transmitter, which transmitter transmits the message from the point of sale terminal to the base station. Preferably the apparatus adapted to reproduce the preset message comprises a headset.

The ability to integrate the system with the existing point of sale terminal system at the checkout removes the need to retrofit substantial additional hardware, reducing the demand on costs. A point of sale terminal system represents a significant investment for retailers, therefore it is important that any new technology is able to be integrated in a cost effective way.

An exemplary embodiment of the invention will now be described in greater detail with reference to the drawings in which:

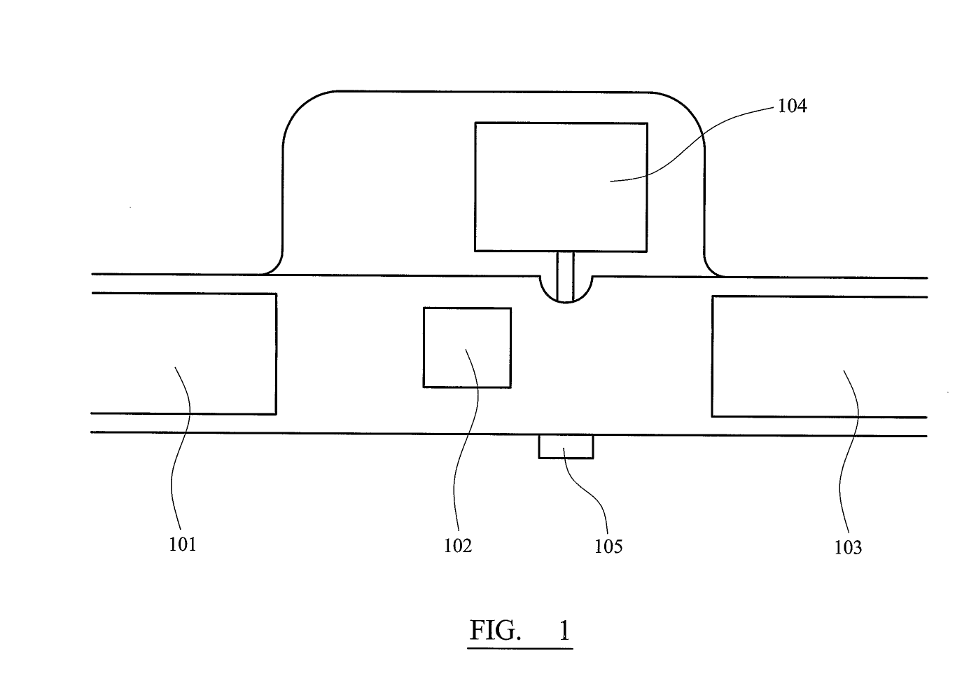

FIG. 1 shows a checkout arrangement

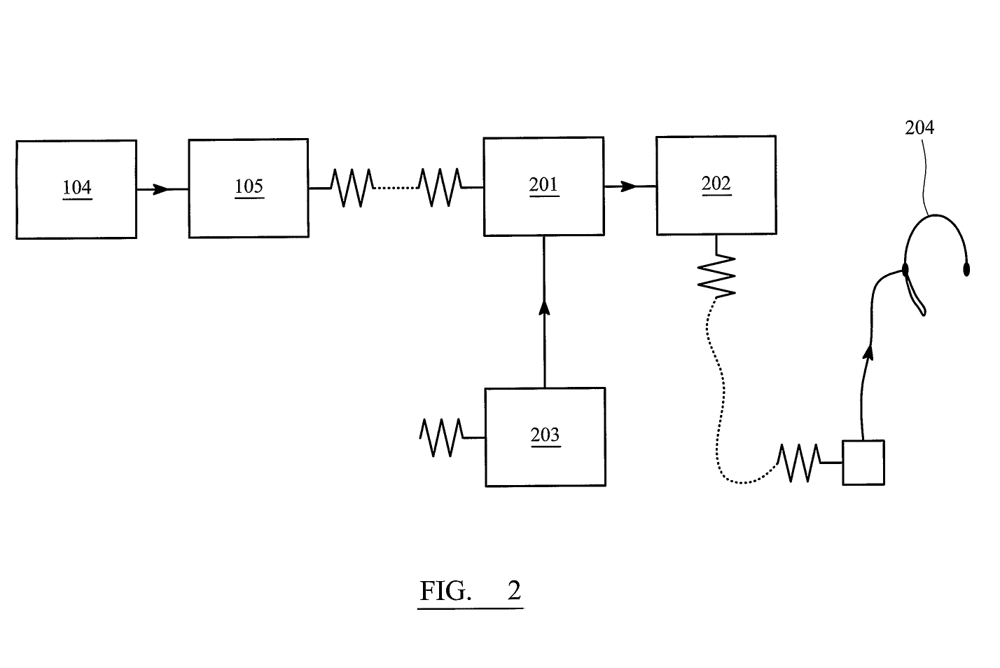

FIG. 2 shows a schematic diagram of supermarket checkouts, base station and headsets.

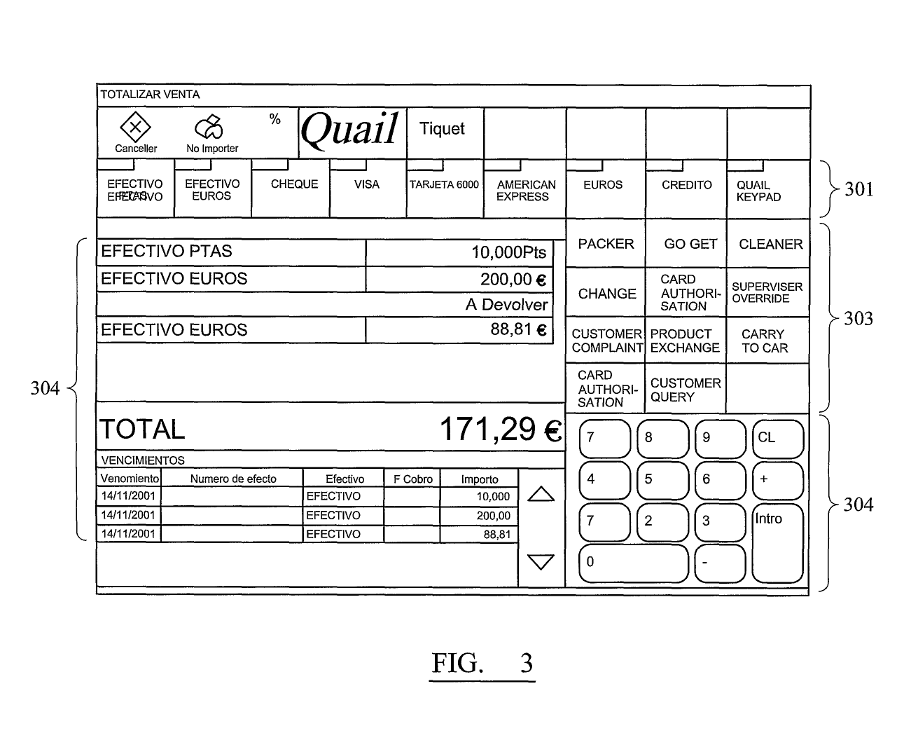

FIG. 3 shows a touch screen point of sale terminal system display

FIG. 1 shows an exemplary embodiment of a checkout arrangement comprising a first conveyor belt 101 for a consumer to unload goods from a trolley or basket onto, a scanner 102 for scanning bar codes on the goods, a second conveyor belt 103 to transport goods from the scanning area to an area where the goods can be placed in bags. The arrangement further comprises a cash box and a touch screen display 104. The touch screen display 104, in use, shows the prices of the goods being purchased and can provide images of unpackaged goods sold by weight so that the operator can select the correct price. The touch screen 104 also provides messages to the operator from the store system. The checkout is further provided with a radio packet transmitter 105 adapted to transmit and receive messages from a base station located remotely from the checkout.

FIG. 2 shows a schematic diagram of the whole system. The touch screen 104 and radio transmitter 105 are located within the checkout area. The master message unit 201 and primary station 202 are located at a location remote to the point of sale terminal but within the range of the UHF signal transmission from the checkouts. To cover a wider area multiple base stations 203 may be used. In certain applications it will be advantageous due to signal quality to use multiple base stations. Secondary slave base stations 203 are linked to the master message unit via a cable link. The master base station 201 is also linked to the primary station 202 which transmits audio signals to the headsets 204 or other audio speaker systems which can be mobile units. When a button is selected from the touch screen 104 by an operator a radio packet is transmitted by the transmitter 105. The radio packet comprises a signal indicating which messages has been selected and the ID of the touch screen. The radio packet is received by the base station 201 which decodes the message and the touch screen ID and the preset message which was selected. The base station 201 then selects the appropriate MP3 pre-recorded audio messages which correspond to the preset message and the location, as specified by the business, which are transferred to the primary station 202 and transmitted from the primary station 202 to the headsets 204 or are connected to another audio speaker system. A headset will typically be worn by a supervisor who can then address the problem without first having to go to the checkout operator to see what the problem is.

Each radio packet transmitter 105 has a unique binary code identification within the system that is set using DIP switches in the transmitter when the system is installed. The transmitter 105 is able to communicate with the base station(s) 201, 203 located within the range of a UHF signal. The communication is simplex, therefore the transmitter 105 is able to send radio packets to the base station 201, 203, but does not receive any radio packets. Simplex communication makes the existing point of sale system easier to modify and reduces the cost of implementing the invention. In order to avoid messages not being received by the base station 201, 203 the same radio packet may be resent a number of times after a random delay by the transmitter 105.

FIG. 3 shows an exemplary touch screen display 104. The touch screen has a number of distinct areas showing distinct functions. At the top of the screen, pre-programmed function keys 301 are provided which enable the display of the prices in an old European currency, in Euros and specify acceptable payment types such as cheque, Visa, in store card, American Express, Diners, other credit cards and a special function, here labelled Quail keypad. Below the symbolic function keys, the screen is divided into two sections. The left hand section 302 shows an itemised bill and total amount due for the transaction in hand. The right hand section is further sub-divided into two with the upper section providing 12 standard pre-set functions 303. The lower section provides a standard numeric keypad 304. The precise arrangement and functions of the various options displayed will generally be specified by the retailer in accordance with the demands of its business. Examples of preset functions include, “packer”, “go get”, “cleaner”, “change”, “supervisor override”, “customer complaint”, “product exchange”, “carry to car”, “card authorization”, “customer query”, and “security” as shown on the touch screen display 104 within the menu 203.

The base stations 201, 203 are able to receive UHF signals from the radio packet transmissions 105. The master base station 201 may be linked to a slave base station 203 in order that radio packet transmissions can be picked up over a wider area. Any transmissions received by a slave base station 203 are sent via a cable to the master base station 201. The master base station 201 decodes the radio message and identifies the transmitter 105 ID and which message was selected from the touch screen 104 menu 303 was pressed to trigger the message. The master base station 201 then selects the appropriate audio messages from the pre-programmed audio memory card which is located in the master base station 201. For example “Till 7” for the identified touch screen, and “cleaner” for the preset message that was selected from the menu 303. An audio transmission to the headset 203 worn by a supervisor enables the supervisor to deal with common problems efficiently, and for more complex problems to be able to take the appropriate action more quickly. This leads to a reduction in time that the transaction at the point of sale terminal is stopped.

1. A digital voice message system comprising a point of sale terminal system having a touch screen adapted to receive inputs from an operator, the inputs including a plurality of inputs relating to preset messages, wherein when an operator selects one of the preset messages, the point of sale terminal sends a message to a transmitter, the message comprising an identifier for the point of sale terminal and an identifier relating to or comprising the preset message, the transmitter being adapted to send a message to apparatus adapted to reproduce the preset message and the point of sale identifier.

2. The digital voice message system according to claim 1 including a base station comprising a data processor, data storage means and data transmission means.

3. The digital voice message system according to claim 2 wherein the point of sale terminal is adapted to transmit a radio message to the base station, which base station includes a primary station and is adapted to receive radio frequency messages.

4. The digital voice message system according to claim 1 wherein a plurality of receivers adapted to reproduce preset messages are provided, receivers being assigned to one or more of a plurality of groups of receivers.

5. The digital voice message system according to claim 3 wherein the receivers are adapted to communicate between each other.

6. The digital voice message system according to claim 2 wherein the receiver adapted to reproduce preset messages is a headset.

7. The digital voice message system according to claim 1 wherein the digital voice message system is adapted to store and stack a number of preset messages.

8. The digital voice message system according to claim 1 wherein messages are assigned priority and the digital voice message system is adapted to prioritise some preset messages over others thereby transmitting high priority messages before low priority messages.
